(19) United States
(12) Patent Application Publication
(10) Pub. No.: US 2019/0349390 A1
(43) Pub. Date: Nov. 14, 2019

(54) PACKET FORMAT INFERENCE APPARATUS AND COMPUTER READABLE MEDIUM

(71) Applicant: Mitsubishi Electric Corporation, Tokyo (JP)

(72) Inventors: Keisuke KITO, Tokyo (JP); Takumi YAMAMOTO, Tokyo (JP); Hiroki NISHIKAWA, Tokyo (JP); Kiyoto KAWAUCHI, Tokyo (JP)

(73) Assignee: Mitsubishi Electric Corporation, Tokyo (JP)

(21) Appl. No.: 16/473,581

(22) PCT Filed: Feb. 6, 2017
(86) PCT No.: PCT/JP2017/004248

§ 371 Date: Jun. 25, 2019

(51) Int. Cl. H04L 29/06; H04L 12/851; H04L 12/841; H04L 12/26; H04L 29/08

(52) U.S. Cl. CPC H04L 63/1408; H04L 47/2441; H04L 67/12; H04L 43/022; H04L 43/028; H04L 47/28

(57) ABSTRACT

A packet format inference apparatus includes a classification unit and an inference unit. The classification unit classifies, among a plurality of packets which are included in a packet data set as packet data and of which formats are unknown, relevant packets transmitted in a fixed cycle, as a packet group having a same arrival cycle. The inference unit infers a packet format for each packet group having the same arrival cycle.

### TECHNICAL FIELD

The present invention relates to a packet format inference apparatus and a packet format inference program.

### BACKGROUND ART

As a cyber attack is diversified, a control system of a factory, a power plant, or the like is aimed at as a target of the attack. A control system network that is constructed by connecting control systems is a network specialized in real-time property, reliability, and fast response of communication. When a control target apparatus is controlled, a physical value is fed back from a sensor mounted on the control target apparatus in a constant cycle, so that an operation command is carried out via the network. Therefore, a packet for the same purpose flows in the control system network for each constant period.

Non-Patent Literature 1 describes a technology for inferring a packet format. “Packet Format Inference” is a technology for receiving, as an input, a packet data set whose data format is unknown, performing a statistical analysis process as a main process, and outputting an inferred packet format. The “packet format” herein is a grammar of packet data and does not include up to semantics of the data. As the grammar of the packet data, a break of the data and whether the data is one of a character, a numeral, or a binary are mainly defined by a protocol.

Specifically, Non-Patent Literature 1 describes the technology for performing the packet format inference by carrying out frequency analysis of unknown packet data for each byte and expressing blocks of a plurality of bytes with high frequencies by a state transition diagram with transition probability.

Patent Literature 1 describes the following technology. In this technology, after a process of computing a feature amount of each flow obtained by carrying out random packet sampling has been repeated for fully-captured traffic a plurality of times, a classifier is generated by associating each flow that has been obtained with a protocol that has been identified for each flow.

Patent Literature 2 describes a technology for determining whether or not traffic volume variation has periodicity.

### CITATION LIST

### Patent Literature

Patent Literature 1: JP 2012-205105 A

Patent Literature 2: JP 2010-283668 A

### Non-Patent Literature

Non-Patent Literature 1: Wang et al., “Biprominer: Automatic Mining of Binary Protocol Features”, IEEE PDCAT 2011, October 2011

### SUMMARY OF INVENTION

### Technical Problem

In the conventional technology for the packet format inference, the statistical analysis process is repetitively performed. Therefore, it takes time to perform the format inference.

An object of the present invention is to speed up packet format inference.

### Solution to Problem

A packet format inference apparatus according to an aspect of the present invention may include:

a classification unit to classify, among a plurality of packets that have arrived, relevant packets transmitted in a fixed cycle, as a packet group having a same arrival cycle; and

an inference unit to infer a packet format for each packet group having the same arrival cycle.

### Advantageous Effects of Invention

In the present invention, packet classification is performed according to the communication cycle, thereby enabling speedup of the packet format inference.

### BRIEF DESCRIPTION OF DRAWINGS

FIG. 1 is a block diagram illustrating a configuration of a packet format inference apparatus according to a first embodiment.

FIG. 2 is a flowchart illustrating operations of the packet format inference apparatus according to the first embodiment.

FIG. 3 is a diagram illustrating an example of a process in step S101 depicted in FIG. 2.

FIG. 4 includes graphs illustrating an example of processes from step S102 to step S104 depicted in FIG. 2.

FIG. 5 is a diagram illustrating an example of a process in step S105 depicted in FIG. 2.

FIG. 6 is a graph illustrating an example of a packet format according to the first embodiment.

FIG. 7 is a block diagram illustrating a configuration of a packet format inference apparatus according to a second embodiment.

FIG. 8 is a flowchart illustrating operations of the packet format inference apparatus according to the second embodiment.

FIG. 9 includes graphs illustrating an example of a process in step S203 depicted in FIG. 9.

FIG. 10 is a flowchart illustrating operations of a packet format inference apparatus according to a third embodiment.

FIG. 11 is a flowchart illustrating operations of a packet format inference apparatus according to a fifth embodiment.

### DESCRIPTION OF EMBODIMENTS

Hereinafter, embodiments of the present invention will be described, using the drawings. A same reference numeral is given to the same or equivalent portions in the respective drawings. In the description of the embodiments, explanations of the same or equivalent portions will be suitably omitted or simplified. The present invention is not limited to the embodiments that will be described below, and various modifications are possible as necessary. To take an example, two or more embodiments of the embodiments that will be described below may be carried out in combination. Alternatively, one embodiment or a combination of two or more embodiments among the embodiments that will be described below may be partially carried out.

### First Embodiment

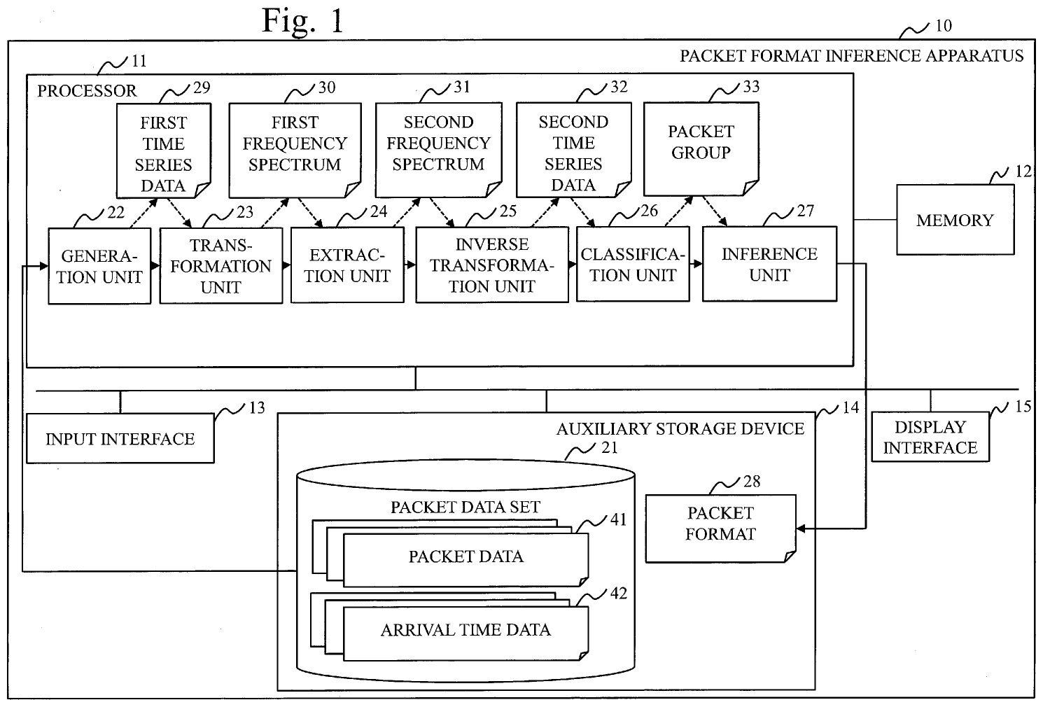

This embodiment will be described, using FIGS. 1 to 6.

### Description of Configuration

A configuration of a packet format inference apparatus 10 according to this embodiment will be described with reference to FIG. 1.

The packet format inference apparatus 10 is a computer. The packet format inference apparatus 10 includes a processor 11 and includes other hardware such as a memory 12, an input interface 13, an auxiliary storage device 14, and a display interface 15. The processor 11 is connected to the other hardware via signal lines and controls these other hardware.

The packet format inference apparatus 10 includes a generation unit 22, a transformation unit 23, an extraction unit 24, an inverse transformation unit 25, a classification unit 26, and an inference unit 27, as functional elements for performing packet format inference. Functions of the generation unit 22, the transformation unit 23, the extraction unit 24, the inverse transformation unit 25, the classification unit 26, and the inference unit 27 are implemented by software.

The processor 11 is an IC to perform arithmetic processing for the packet format inference or the like. The “IC” is an abbreviation for Integrated Circuit. The processor 11 is a CPU, for example. The “CPU” is an abbreviation for Central Processing Unit.

The memory 12 is a medium to hold an operation result and so on. The memory 12 is a flash memory or a RAM, for example. The “RAM” is an abbreviation for “Random Access Memory”.

The input interface 13 is an interface to connect an apparatus to accept an input from a user. As the apparatus to accept the input from the user, there is a mouse, a keyboard, or a touch panel, for example.

The auxiliary storage device 14 is a medium for storing data. The auxiliary storage device 14 is a flash memory or an HDD, for example. The “HDD” is an abbreviation for Hard Disk Drive.

The display interface 15 is an interface to connect a display to display a result or the like on a screen. As the display, there is an LCD, for example. The “LCD” is an abbreviation for Liquid Crystal Display.

Though not illustrated, the packet format inference apparatus 10 may include a communication apparatus, as hardware.

The communication apparatus includes a receiver to receive data and a transmitter to transmit data. The communication apparatus is a communication chip or an NIC, for example. The “NIC” is an abbreviation for Network Interface Card.

The packet format inference apparatus 10 reads, from the auxiliary storage device 14, a packet data set 21 that holds a plurality of packets whose formats are unknown as packet data 41 and holds an arrival time of each packet as arrival time data 42. After the packet format inference apparatus 10 has performed the packet format inference using the packet data set 21, the packet format inference apparatus 10 writes into the auxiliary storage device 14 a packet format 28 that has been inferred.

The packet format inference apparatus 10 may receive an input of the packet data set 21 from the user via the input interface 13. The packet format inference apparatus 10 may receive the packet data set 21 from an external apparatus via the receiver.

The packet format inference apparatus 10 may display the inferred packet format 28 on the screen via the display interface 15. The packet format inference apparatus 10 may transmit the inferred packet format 28 to an external apparatus via the transmitter.

A packet format inference program that is a program to implement the functions of the generation unit 22, the transformation unit 23, the extraction unit 24, the inverse transformation unit 25, the classification unit 26, and the inference unit 27 is stored in the auxiliary storage device 14. The packet format inference program is loaded into the memory 12 and is executed by the processor 11. An OS is also stored in the auxiliary storage device 14. The “OS” is an abbreviation for Operating System. The processor 11 executes the packet format inference program while executing the OS. A part or all of the packet format inference program may be incorporated into the OS.

The packet format inference apparatus 10 may include a plurality of processors to substitute the processor 11. These plurality of processors share execution of the packet format inference program. Each processor is an IC to perform arithmetic processing for the packet format inference or the like, like the processor 11.

Information, data, signal values, and variable values indicating results of processes of the generation unit 22, the transformation unit 23, the extraction unit 24, the inverse transformation unit 25, the classification unit 26, and the inference unit 27 are stored in the memory 12, the auxiliary storage device 14, or a register or a cache register in the processor 11.

The packet format inference program may be stored in a portable recording medium such as a magnetic disk or an optical disk.

### Description of Operations

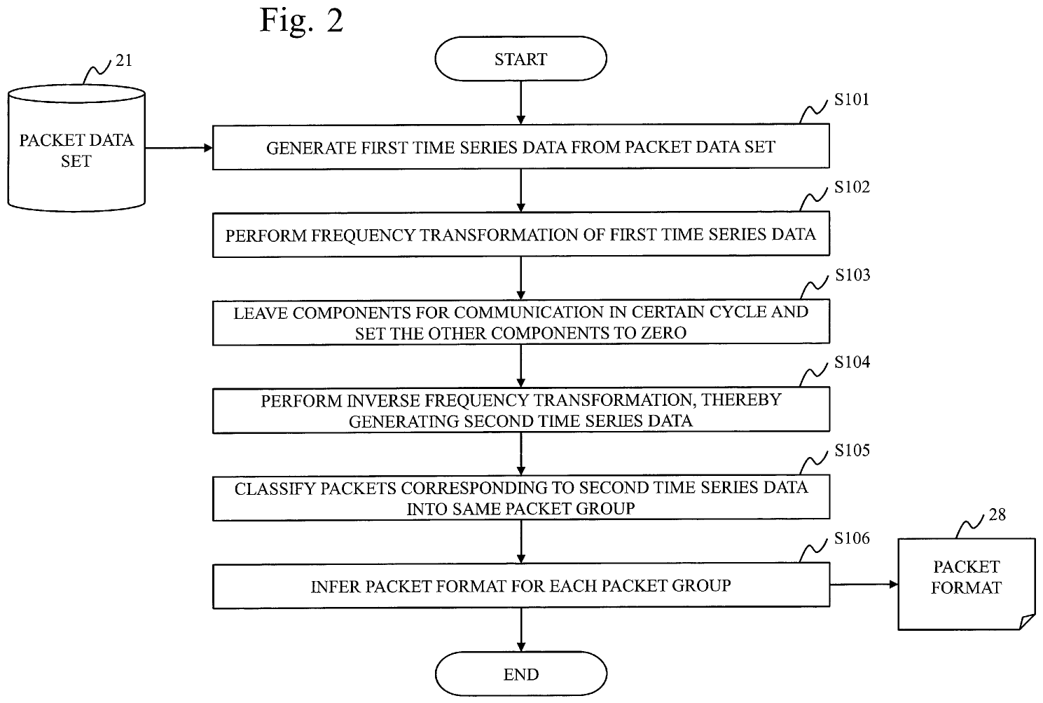

Operations of the packet format inference apparatus 10 according to this embodiment will be described with reference to FIG. 2. The operations of the packet format inference apparatus 10 correspond to a packet format inference method according to this embodiment.

In step S101, the generation unit 22 extracts data having a same length from a same location of each packet included in at least a portion of packets among a plurality of packets. In this embodiment, all the packets among the “plurality of packets” which are included in the packet data set 21 as the packet data 41 and of which formats are unknown correspond to the “at least a portion of the packets”. The generation unit 22 generates first time series data 29 indicating a value of the data that has been extracted, as an amplitude corresponding to the arrival time of each packet.

Specifically, the generation unit 22 reads, from the auxiliary storage device 14, the packet data set 21 as an input. The generation unit 22 equally extracts a portion at the same location such as a location being 10 bytes from the beginning of each packet in the packet data set 21 and associates the portion with the arrival time data 42, thereby generating the first time series data 29. The generation unit 22 outputs the first time series data 29 to the transformation unit 23.

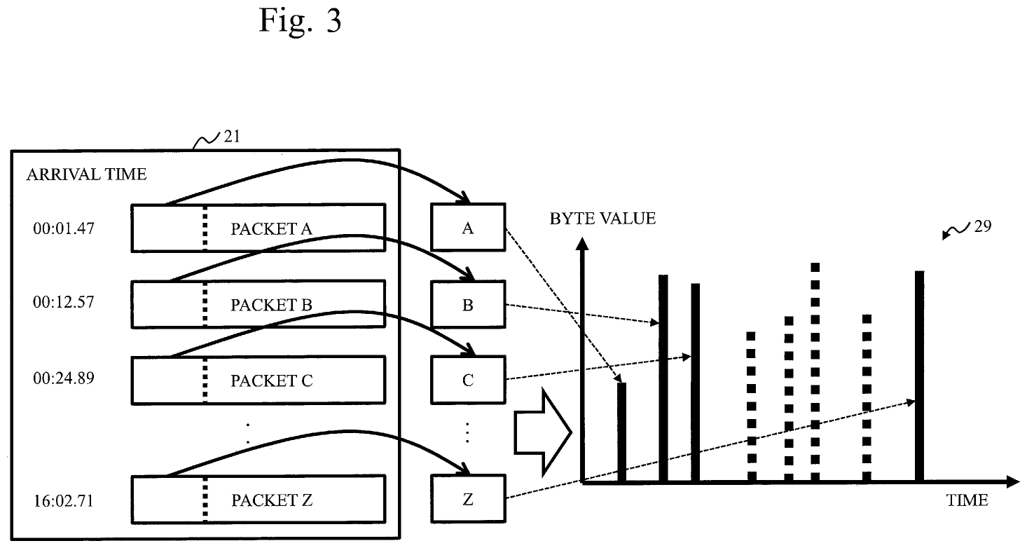

FIG. 3 illustrates an example of the process of generating the first time series data 29 from the packet data set 21. In the example in FIG. 3, the beginning portion of each packet in the packet data set 21 is captured. The binary value of the portion that has been captured is associated with the amplitude of the first time series data 29 and the arrival time is associated with a time axis. Preferably, the portion that has been captured from each packet is the one that is characterized according to the purpose of the packet. Thus, preferably, a so-called header portion or the beginning portion of each packet is captured. The length of the portion to be captured may be changed according to the performance of the processor 11 to perform the process. Alternatively, when an SIMD function of the processor 11 is used, by adjusting the length of the portion to be captured to a data length that can be handled by SIMD, a high-speed process can be expected. The “SIMD” is an abbreviation for Single Instruction Multiple Data.

In step S102, the transformation unit 23 performs frequency transformation of the first time series data 29 generated by the generation unit 22, and outputs a first frequency spectrum 30.

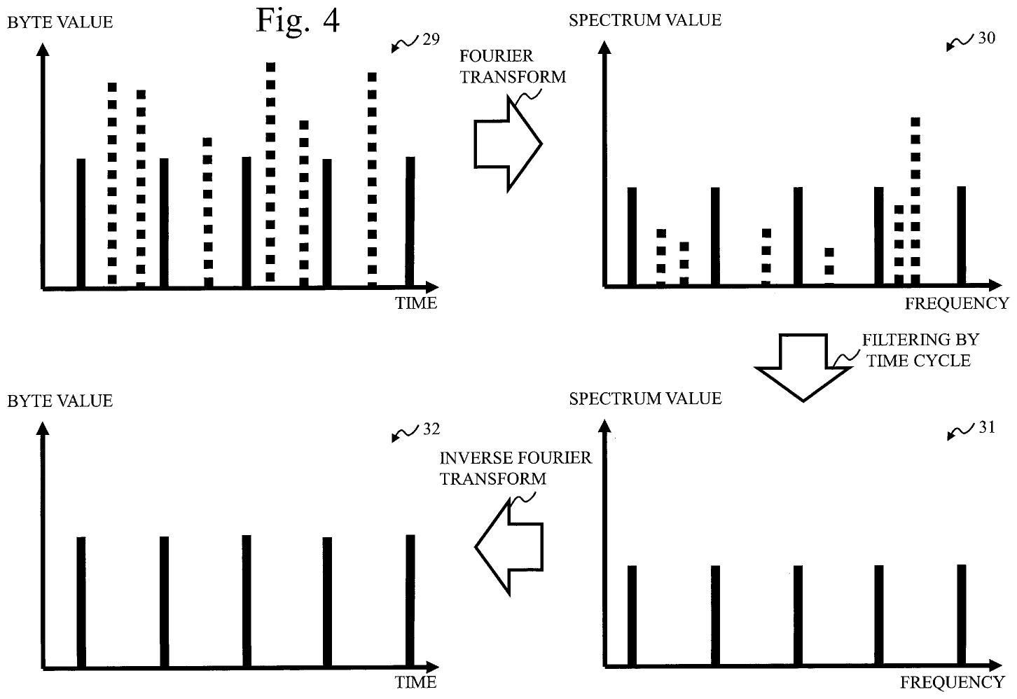

Specifically, the transformation unit 23 receives the first time series data 29 as an input. As in an example illustrated in FIG. 4, the transformation unit 23 performs a discrete fast Fourier transform, thereby generating the first frequency spectrum 30. The transformation unit 23 outputs the first frequency spectrum 30 to the extraction unit 24.

An arbitrary algorithm can be used for the frequency transformation. A discrete Fourier transform may be likewise used, instead of the discrete fast Fourier transform. The transformation unit 23 applies a Hamming window or a window function such as the Hamming window to the first time series data 29 before the transformation unit 23 performs the frequency transformation.

In step S103, the extraction unit 24 extracts, from the first frequency spectrum 30 output by the transformation unit 23, a frequency component Fx corresponding to a certain cycle Cx, and outputs a second frequency spectrum 31. That is, the extraction unit 24 performs a process of leaving the component Fx for communication in the certain cycle Cx and setting the other components to zero.

Specifically, the extraction unit 24 receives the first frequency spectrum 30 as an input. As in the example illustrated in FIG. 4, the extraction unit 24 leaves only each spectrum component corresponding to a cycle desired to be extracted and eliminates the components other than the spectrum component corresponding to the cycle desired to be extracted, thereby generating the second frequency spectrum 31. The extraction unit 24 outputs the second frequency spectrum 31 to the inverse transformation unit 25.

The cycle desired to be extracted is set to be plural in advance. If a mean value when portions corresponding to the set cycle have been extracted exceeds the mean value of a whole spectrum, the extraction unit 24 determines that a corresponding periodic signal is present and extracts the spectrum component. The extraction unit 24 repeats this process just corresponding to the number of the cycles desired to be extracted.

The extraction unit 24 outputs the second frequency spectrum 31 just corresponding to the number of the cycles desired to be extracted. In this embodiment, the spectrum to be used for the extraction is a power spectrum that is the square root of the sum of squares of each spectrum of a real part and an imaginary part after the frequency transformation. Each of the real part and the imaginary part may also be used for the extraction. Since the spectrum may appear for just one of the real part and the imaginary part due to a phase deviation from an ideal periodic signal, the phase deviation needs to be considered.

In step S104, the inverse transformation unit 25 performs inverse frequency transformation of each second frequency spectrum 31 output from the extraction unit 24, and outputs second time series data 32.

Specifically, the inverse transformation unit 25 receives the second frequency spectrum 31 as an input. The inverse transformation unit 25 performs an operation for the second frequency spectrum 31 corresponding to the inverse operation of the operation by the transformation unit 23, thereby generating the second time series data 32. That is, the inverse transformation unit 25 performs an inverse discrete fast Fourier transform of the second frequency spectrum 31, thereby generating the second time series data 32, as in the example illustrated in FIG. 4. The inverse transformation unit 25 outputs the second time series data 32 to the classification unit 26.

An arbitrary algorithm may be used for the inverse frequency transformation if the arbitrary algorithm handles the frequency transformation. An inverse discrete Fourier transform may be likewise used, instead of the inverse discrete fast Fourier transform.

The inverse transformation unit 25 outputs the second time series data 32 just corresponding to the number of the second frequency spectrum 31 that have been input.

In step S105, the classification unit 26 identifies relevant packets transmitted in the cycle Cx by referring to the second time series data 32 output from the inverse transformation unit 25. The cycle Cx is a fixed cycle. That is, the “relevant packets” are packets transmitted at equal time intervals. The classification unit 26 classifies the relevant packets that have been identified, as a packet group 33 having a same arrival cycle. That is, the classification unit 26 classifies, among the plurality of packets that have arrived, the relevant packets transmitted in the fixed cycle, as the packet group 33 having the same arrival cycle.

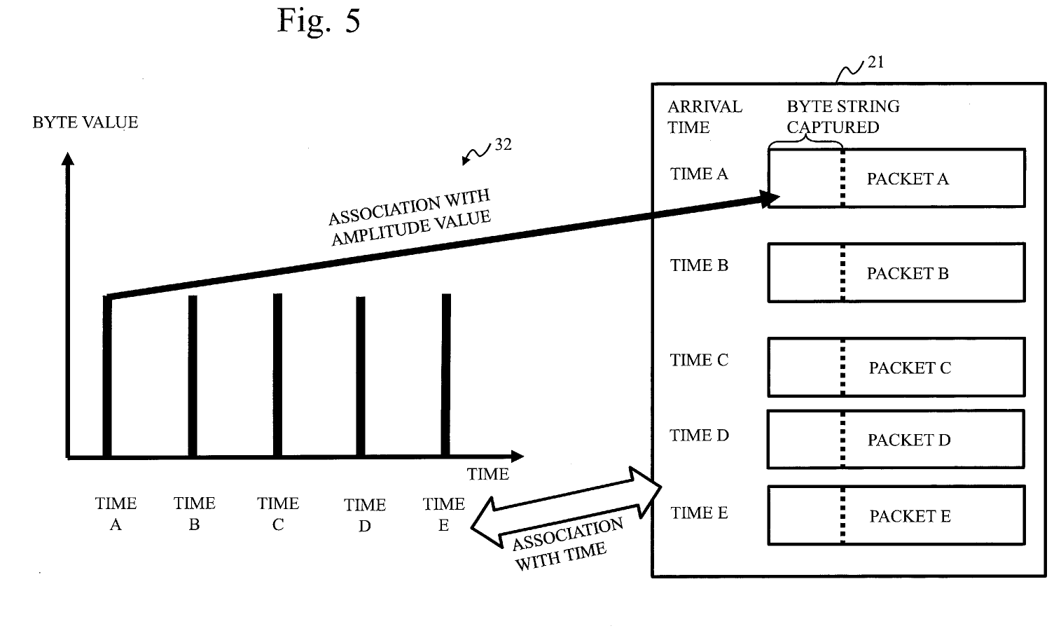

Specifically, the classification unit 26 receives the second time series data 32 as an input. As in an example illustrated in FIG. 5, the classification unit 26 searches the packet data set 21 for each packet corresponding to a byte value and a time in the second time series data 32 and classifies each packet that has been extracted into a same packet group 33. That is, the classification unit 26 classifies the packets in the packet data set 21 into the packet groups 33 that are different according to the cycles desired to be extracted. The classification unit 26 outputs the packet group 33 for each cycle to the inference unit 27.

In the packet search, a value or a time may not exactly match due to an error caused by the frequency analysis process from step S102 to step S104. Therefore, if the byte value of the captured portion of the packet and the arrival time of the packet are within certain ranges, which have been set in advance by the user, from the byte value and the time in the second time series data 32, the classification unit 26 regards that the byte value of the captured portion of the packet and the arrival time of the packet match the byte value and the arrival time in the second time series data 32.

The classification unit 26 performs the above-mentioned process for each second time series data 32 that has been received, thereby classifying the packets in the packet data set 21 into a plurality of the packet groups 33.

In step S106, the inference unit 27 infers a packet format 28 for each packet group 33 having the same arrival cycle.

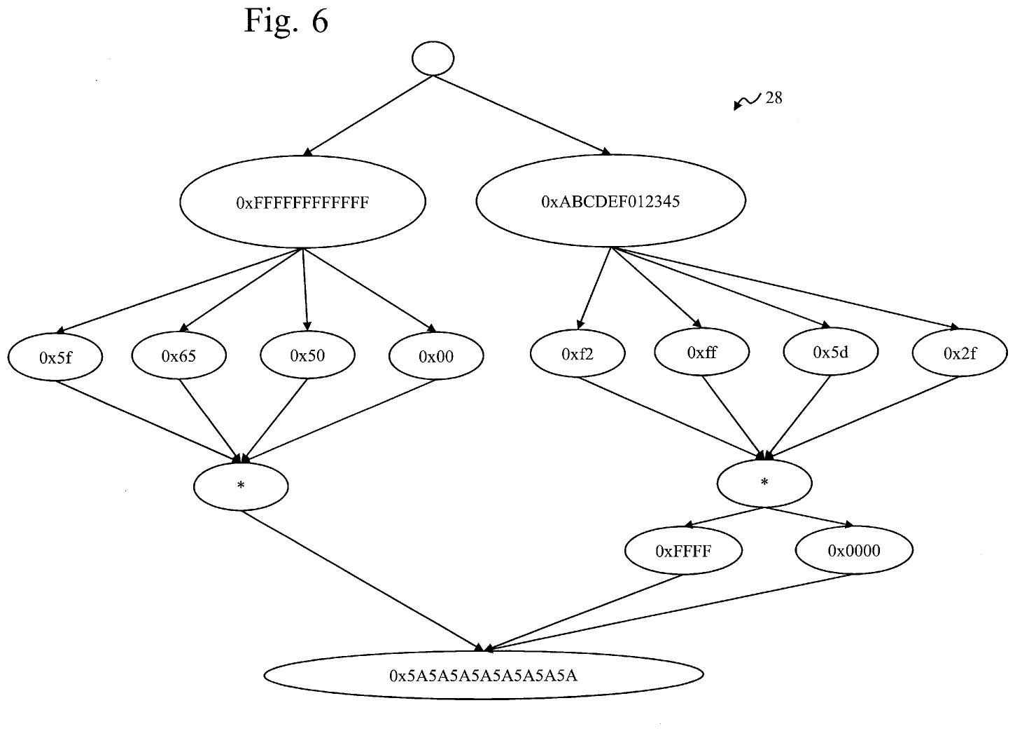

Specifically, the inference unit 27 receives the packet group 33 for each cycle, as an input. The inference unit 27 performs packet format inference for each packet group 33, using an algorithm which is the same as that in Non-Patent Literature 1 or a different algorithm. As a result, one common packet format 28 is inferred for the packets that have been classified into the same packet group 33. The inference unit 27 writes, into the auxiliary storage apparatus 14, the packet format 28 that has been inferred, as an output. As the data structure of the packet format 28, an arbitrary data structure can be used. In this embodiment, however, a graph as in an example illustrated in FIG. 6 is used.

### Description of Effect of Embodiment

In this embodiment, each packet is classified according to the communication cycle, thereby enabling speedup of the packet format inference.

In the control system network described above, periodic communication is often performed. A communication cycle is a specific one to be set according to the control target apparatus. That is, the communication cycle is greatly related to intended communication content. To take an example, the periodic communication aiming at control of the number of revolutions of a motor is performed in a cycle suited to the motor or the control target apparatus on which the motor is mounted. The great relation of the communication cycle to the communication content means that the communication cycle is associated with packet content. Accordingly, classification of each packet according to the communication cycle as in this embodiment leads to classification of the packet for each content. In this embodiment, each packet is classified according to the communication cycle. Each packet that is transmitted by communication for a same purpose can be thereby classified into the same packet group 33, and as a result, a statistically significant difference can be readily obtained. That is, in this embodiment, by classifying each packet according to the communication cycle, the packets having the same purpose and a same feature can be identified. Thus, packet format inference can be performed just by a simple statistical analysis process. Thus, the packet format inference is sped up.

### Alternative Configuration

In this embodiment, the functions of the generation unit 22, the transformation unit 23, the extraction unit 24, the inverse transformation unit 25, the classification unit 26, and the inference unit 27 are implemented by the software. As a variation example, however, the functions of the generation unit 22, the transformation unit 23, the extraction unit 24, the inverse transformation unit 25, the classification unit 26, and the inference unit 27 may be implemented by hardware. That is, the functions of the generation unit 22, the transformation unit 23, the extraction unit 24, the inverse transformation unit 25, the classification unit 26, and the inference unit 27 may be implemented by a dedicated electronic circuit.

The dedicated electronic circuit is a single circuit, a composite circuit, a programmed processor, a parallel programmed processor, a logic IC, a GA, an FPGA, or an ASIC, for example. The “GA” is an abbreviation for Gate Array. The “FPGA” is an abbreviation for Field-Programmable Gate Array. The “ASIC” is an abbreviation for Application Specific Integrated Circuit.

As another variation example, the functions of the generation unit 22, the transformation unit 23, the extraction unit 24, the inverse transformation unit 25, the classification unit 26, and the inference unit 27 may be implemented by a combination of software and hardware. That is, a part of the functions of the generation unit 22, the transformation unit 23, the extraction unit 24, the inverse transformation unit 25, the classification unit 26, and the inference unit 27 may be implemented by a dedicated electronic circuit, and the remainder of the functions of the generation unit 22, the transformation unit 23, the extraction unit 24, the inverse transformation unit 25, the classification unit 26, and the inference unit 27 may be implemented by the software.

The processor 11, the memory 12, and the dedicated electronic circuit are collectively referred to as “processing circuitry”. That is, irrespective of whether the functions of the generation unit 22, the transformation unit 23, the extraction unit 24, the inverse transformation unit 25, the classification unit 26, and the inference unit 27 are implemented by the software, by the hardware, or by the combination of the software and the hardware, the functions of the generation unit 22, the transformation unit 23, the extraction unit 24, the inverse transformation unit 25, the classification unit 26, and the inference unit 27 are implemented by the processing circuitry.

The “apparatus” in the packet format inference apparatus 10 may be read as a “method”, each “unit” of the generation unit 22, the transformation unit 23, the extraction unit 24, the inverse transformation unit 25, the classification unit 26, and the inference unit 27 may be read as a “step”. Alternatively, the “apparatus” in the packet format inference apparatus 10 may be read as a “program”, a “program product”, or a “computer-readable medium on which a program is recorded”, and each “unit” of the generation unit 22, the transformation unit 23, the extraction unit 24, the inverse transformation unit 25, the classification unit 26, and the inference unit 27 may be read as a “procedure” or a “process”.

### Second Embodiment

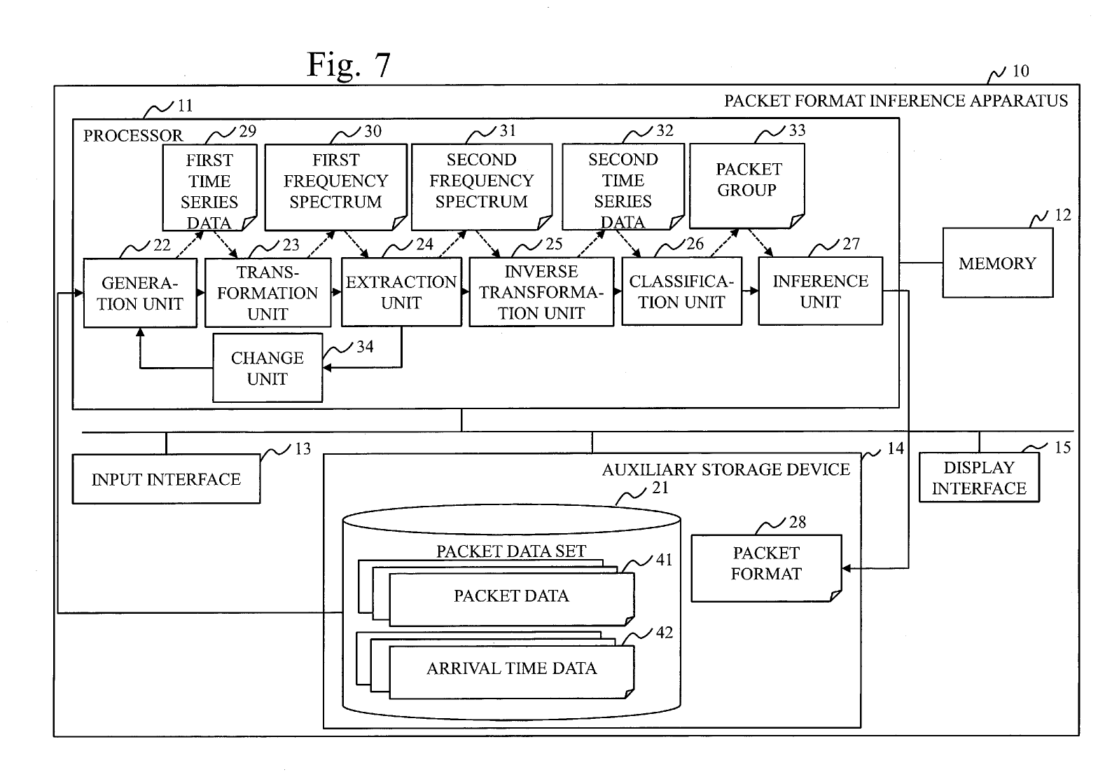

A difference of this embodiment from the first embodiment will be mainly described, using FIGS. 7 to 9.

### Description of Configuration

A configuration of a packet format inference apparatus 10 according to this embodiment will be described with reference to FIG. 7.

The packet format inference apparatus 10 includes a change unit 34, in addition to a generation unit 22, a transformation unit 23, an extraction unit 24, an inverse transformation unit 25, a classification unit 26, and an inference unit 27, as functional components for performing packet format inference. Functions of the generation unit 22, the transformation unit 23, the extraction unit 24, the inverse transformation unit 25, the classification unit 26, and the inference unit 27, and the change unit 34 are implemented by software.

A packet format inference program that is a program to implement the functions of the generation unit 22, the transformation unit 23, the extraction unit 24, the inverse transformation unit 25, the classification unit 26, the inference unit 27, and the change unit 34 is stored in an auxiliary storage device 14. The packet format inference program is loaded into a memory 12 and is executed by a processor 11.

Information, data, signal values, and variable values indicating results of processes of the generation unit 22, the transformation unit 23, the extraction unit 24, the inverse transformation unit 25, the classification unit 26, the inference unit 27, and the change unit 34 are stored in the memory 12, the auxiliary storage device 14, or a register or a cache register in the processor 11.

### Description of Operations

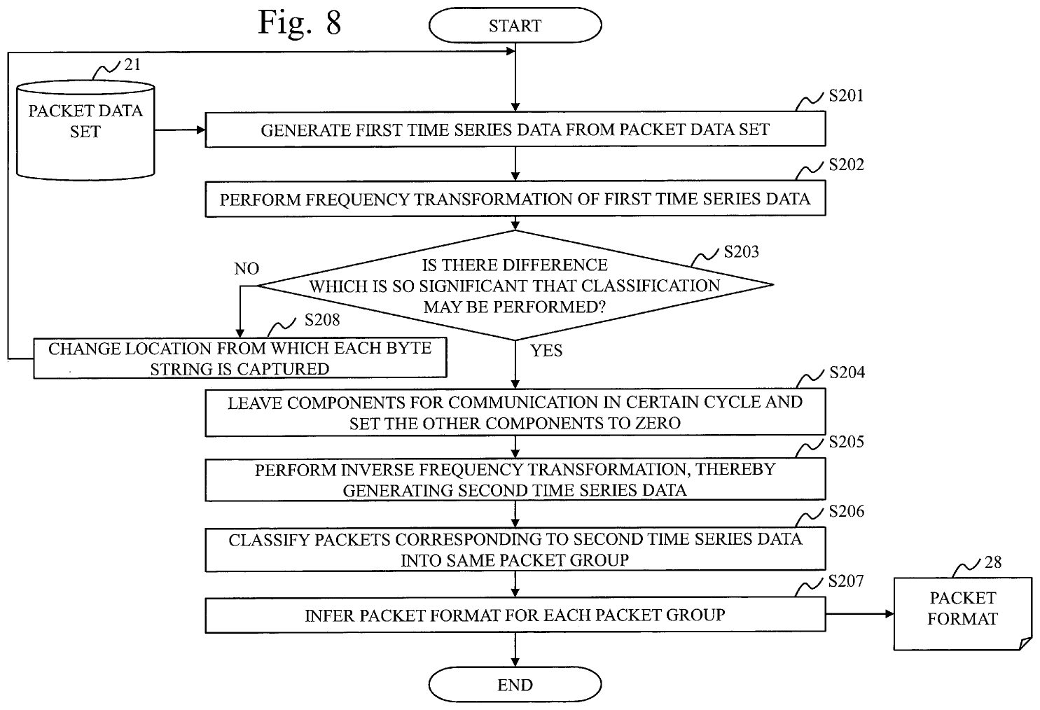

Operations of the packet format inference apparatus 10 according to this embodiment will be described with reference to FIG. 8. The operations of the packet format inference apparatus 10 correspond to a packet format inference method according to this embodiment.

It is assumed in the first embodiment that a difference which is so significant that a packet communication cycle can be extracted in a frequency region appears in the frequency analysis process from step S102 to step S104. In this embodiment, a process, in case that the significant difference does not appear in the frequency region and the extraction in the frequency region has become difficult, is added. Specifically, when there is not the significant difference, a procedure for executing processes from generation of first time series data 29 again is added. The “significant difference” herein means a difference such as the one that exceeds a threshold range set in advance by a user rather than the mean value of a frequency spectrum.

Processes in step S201 and step S202 are the same as those in step S101 and step S102.

In step S203, the change unit 34 compares each frequency component Fx, corresponding to a cycle Cx, included in a first frequency spectrum 30 output from the transformation unit 23 with a reference value Vs. If the frequency component Fx is larger than the reference value Vs or if the frequency component Fx is the same as the reference value Vs, processes after step S204 are performed. On the other hand, if the frequency component Fx is smaller than the reference value Vs, a process in step S208 is performed.

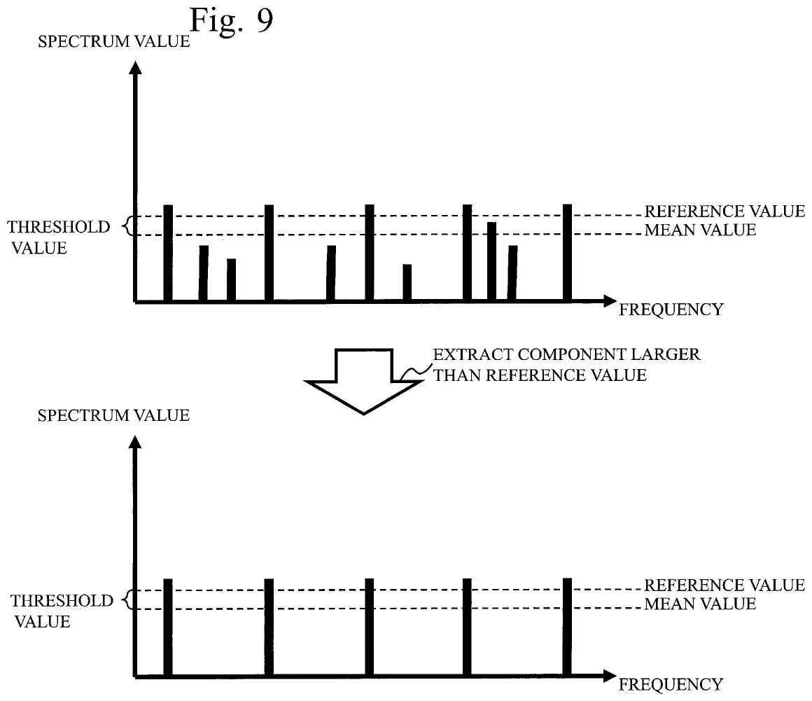

Specifically, the change unit 34 extracts, from the first frequency spectrum 30, each component that is larger than the reference value Vs, as in an example illustrated in FIG. 9, and determines whether there is a difference which is so significant that a spectrum corresponding to constant periodic communication may be extracted. If there is the significant difference, the processes after step S204 are performed. On the other hand, if there is not the significant difference, the process in step S208 is performed.

In step S208, the change unit 34 changes the location of each packet included in at least a portion of packets among a plurality of packets, from which data is extracted by the generation unit 22. Then, the processes after step S201 are performed again. In this embodiment, all the packets of the “plurality of packets” which are included in a packet data set 21 as packet data 41 and of which formats are unknown correspond to the “at least a portion of the packets”, as in the first embodiment.

Specifically, the change unit 34 changes the location from which a portion is capture from each packet in the process in step S201 to be performed again, and specifies, for the generation unit 22, a location for the capture after the change. As a specific example, it is assumed that in the process in step S201 that has been executed for a first time, the generation unit 22 has captured first 10 bytes of the packet. If the significant difference cannot be obtained in the process in step S202, the generation unit 22 extracts, from the 11th byte from the beginning, a portion corresponding to 10 bytes, in a subsequent step S201. Thereafter, the same process is performed, and the process in step S201 is performed by changing the location for the capture until the significant difference is obtained in the process in step S202. As a method of changing the location for the capture, various methods can be used including a method of sliding the location for the capture to a rear side of data in the order of a portion corresponding to 10 bytes from the 6th byte from the beginning or a portion corresponding to 10 bytes from the 11th byte from the beginning, or the like.

The change unit 34 repeats the above-mentioned process a certain number of times set by the user. If the significant difference cannot be obtained, the change unit 34 outputs an error indicating that no cycle can be extracted.

The processes from step S204 to step S207 are the same as those from step S103 to step S106.

### Description of Effect of Embodiment

In the first embodiment, when the portion that has been captured from a packet by the generation unit 22 has been a random bit string such as a data portion or a CRC, the portion that has been captured is time series data such as white noise even if a periodic signal is included in that packet. The “CRC” is an abbreviation for “Cyclic Redundancy Check”. On the other hand, in this embodiment, if the portion that has been captured by the generation unit 22 from a packet for periodic communication is not data having a certain value, different data is extracted from the same packet. Time series data capable of detecting the periodic communication can be thereby obtained. As a result, it becomes possible to perform packet classification with higher accuracy.

### Alternative Configuration

In this embodiment, the functions of the generation unit 22, the transformation unit 23, the extraction unit 24, the inverse transformation unit 25, the classification unit 26, the inference unit 27, and the change unit 34 are implemented by the software, as in the first embodiment. However, the functions of the generation unit 22, the transformation unit 23, the extraction unit 24, the inverse transformation unit 25, the classification unit 26, the inference unit 27, and the change unit 34 may be implemented by hardware, as in the variation example in the first embodiment. Alternatively, the functions of the generation unit 22, the transformation unit 23, the extraction unit 24, the inverse transformation unit 25, the classification unit 26, the inference unit 27, and the change unit 34 may be implemented by a combination of software and hardware.

### Third Embodiment

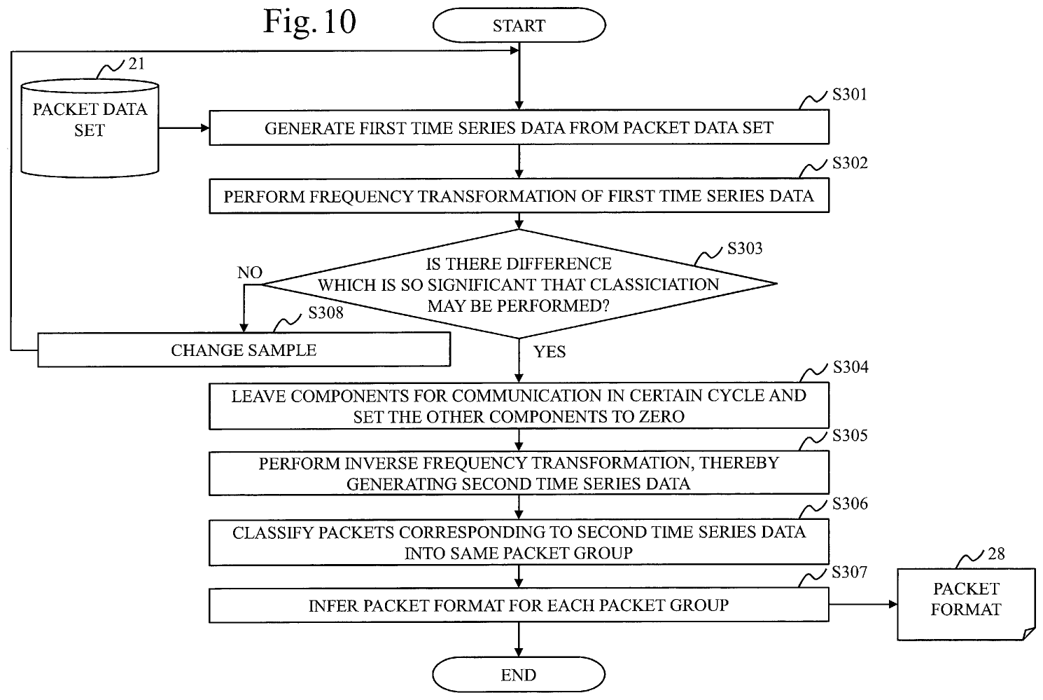

A difference of this embodiment from the second embodiment will be mainly described, using FIG. 10.

### Description of Configuration

A configuration of a packet format inference apparatus 10 according to this embodiment is the same as that in the second embodiment illustrated in FIG. 7.

### Description of Operations

Operations of the packet format inference apparatus 10 according to this embodiment will be described with reference to FIG. 10. The operations of the packet format inference apparatus 10 correspond to a packet format inference method according to this embodiment.

In the second embodiment, when separate periodic communications occur in a same cycle, those communications cannot be distinguished. On the other hand, in this embodiment, such separate periodic communications can be distinguished.

When the separate periodic communications occur in the same cycle, it is anticipated that a first frequency spectrum 30 after frequency transformation will not become an intended spectrum and that extraction of each frequency component Fx corresponding to a cycle Cx will therefore become difficult. When the extraction of the frequency component Fx corresponding to the cycle Cx is determined to be difficult, the problem can be addressed by decimating, from time series data, data whose value is close.

In step S301, a generation unit 22 selects one of a plurality of packets as a sample. In this embodiment, the one of the “plurality of packets” which are included in a packet data set 21 as packet data 41 and of which formats are unknown is randomly selected as the sample. The generation unit 22 uses each packet among the “plurality of packets”, which has a value within a set range Rs from the value of the sample, as “at least a portion of the packets”. That is, the generation unit 22 extracts, from a same location of each packet having the value within the set range Rs from the value of the sample, data having a same length. The generation unit 22 generates first time series data 29 indicating the value of the data that has been extracted, as an amplitude corresponding to the arrival time of each packet.

The filtering process of narrowing down the “plurality of packets” to each packet having the value within the set range Rs from the value of the sample may be performed for the packet data set 21 or time series data generated for all the packets among the “plurality of packets”. In the former case, time series data generated just for each packet after the filtering is output as the first time series data 29 without alteration. In the latter case, the time series data generated for all the packets before the filtering is converted to the first time series data 29.

The set range Rs may be a fixed range such as plus/minus 5 that has been set by a user in advance, or may be a variable range that is suitably set by the generation unit 22. As a specific example of the latter set range, the following range can be set. That is, when a relationship of the number of the packets corresponding to an increase in the range of values is considered, the secondary differentiation of the increase is calculated, and a certain range from a value in which the secondary differentiation becomes 0 can be set to the allowable range of the extraction. When the time series data before the filtering is converted to the first time series data 29 by the filtering, it can be determined whether the filtering has been successful by applying , when the filtering has been performed, a cross-correlation function and an ideal periodic signal for the time series data obtained. A periodic signal is a signal referred to as a periodic delta function or a comb function. When the filtering is successful, correlation is established at only the portion of zero.

Processes in step S302 and step S303 are the same as those in step S202 and step S203. If there is a significant difference in step S303, processes after step S304 are performed. On the other hand, if there is not the significant difference, a process in step S308 is performed.

In step S308, the change unit 34 changes the sample that is selected by the generation unit 22. Then, the processes after step S301 are performed again.

In this embodiment, random packet sampling is performed. Thus, each packet that is randomly selected is not necessarily a packet for periodic communication. Therefore, as mentioned above, the processes in step S301 and step S302 are performed until the packet for the periodic communication is selected and the significant difference appears. The number of times of the sampling is set by the user in advance. In step S301, instead of performing the random sampling, a method of selecting the packet in the ascending order of arrival times may be used. When this method is used, the user sets, in advance. the number of the packets that should be selected, starting from the beginning of the order of arrivals.

The processes from step S304 to step S307 are the same as those from step S204 to step S207.

### Description of Effect of Embodiment

According to this embodiment, when the separate periodic communications occur in the same cycle, those separate periodic communications can be distinguished. As a result, it becomes possible to perform packet classification with higher accuracy.

### Alternative Configuration

In step S301, the generation unit 22 may use, among the “plurality of packets”, each packet whose hamming distance with the sample is within a set range, as the “at least a portion of the packets”. That is, as a variation example, the generation unit 22 may extract, from a same location of each packet whose hamming distance with the sample is within the set range, data having the same length. The generation unit 22 generates first time series data 29 indicating the value of the data that has been extracted, as an amplitude corresponding to the arrival time of each packet.

### Fourth Embodiment

A difference of this embodiment from the third embodiment will be mainly described.

In the third embodiment, only each packet whose value or hamming distance is within the certain range is extracted, and a value captured from the packet is used for the time series data to be output. When the time series data that has been generated is data of a succession of close values, this method cannot be applied.

As a time series data generation method, a method can be used where a value obtained by subtracting, from a maximum value that can be possible in time series data, a hamming distance with a packet that has been randomly sampled, is newly applied as a binary value in the time series data. With this method, a packet whose value is close but which is different in terms of a binary string can be excluded. Generally, a hamming distance between an arbitrary binary string and a binary string that has been randomly generated is a half of the bit length. Accordingly, discarding, from the time series data that has been newly generated, each packet having a value that is less than a half of an assumable value, data corresponding to each packet for periodic communication is readily extracted. The process of the discarding may or may not be performed. By calculating a correlation function with an ideal periodic delta function, it can be determined which one of the time series data generation method with the process of the discarding or the time series data generation method without the process of the discarding is successful in the extraction.

In step S301, a generation unit 22 selects one of a plurality of packets as a sample. In this embodiment, the one of the “plurality of packets” which are included in a packet data set 21 as packet data 41 and of which formats are unknown is randomly selected as the sample. The generation unit 22 calculates a value obtained by subtracting, from a common value Vc to each packet that is included in at least a portion of the packets among the “plurality of packets”, a hamming distance between the sample and each packet. In this embodiment, all the packets among the “plurality of packets” correspond to the “at least a portion of the packets”. An arbitrary fixed value can be used as the common value Vc. In this embodiment, however, a maximum value that can be possible in time series data is used. The generation unit 22 generates first time series data 29 indicating the value that has been calculated, as an amplitude corresponding to the arrival time of each packet.

Processes after step S302 are the same as those in the third embodiment.

According to this embodiment, the time series data, in which each packet close to a specific packet in terms of a binary string has been emphasized, can be obtained. Improvement in accuracy of packet classification in each cycle time can be expected.

### Alternative Configuration

As a time series data generation method, a method may be used where the hamming distance itself with the packet that has been randomly sampled is newly applied as a binary value in time series data. That is, in step S301, the generation unit 22 may calculate the hamming distance between each packet that is included in the “at least a portion of the packets” and the sample, instead of the value obtained by subtracting, from the common value Vc to each packet, the hamming distance between the sample and each packet. The generation unit 22 generates first time series data 29 indicating the hamming distance that has been calculated, as an amplitude corresponding to the arrival time of each packet.

### Fifth Embodiment

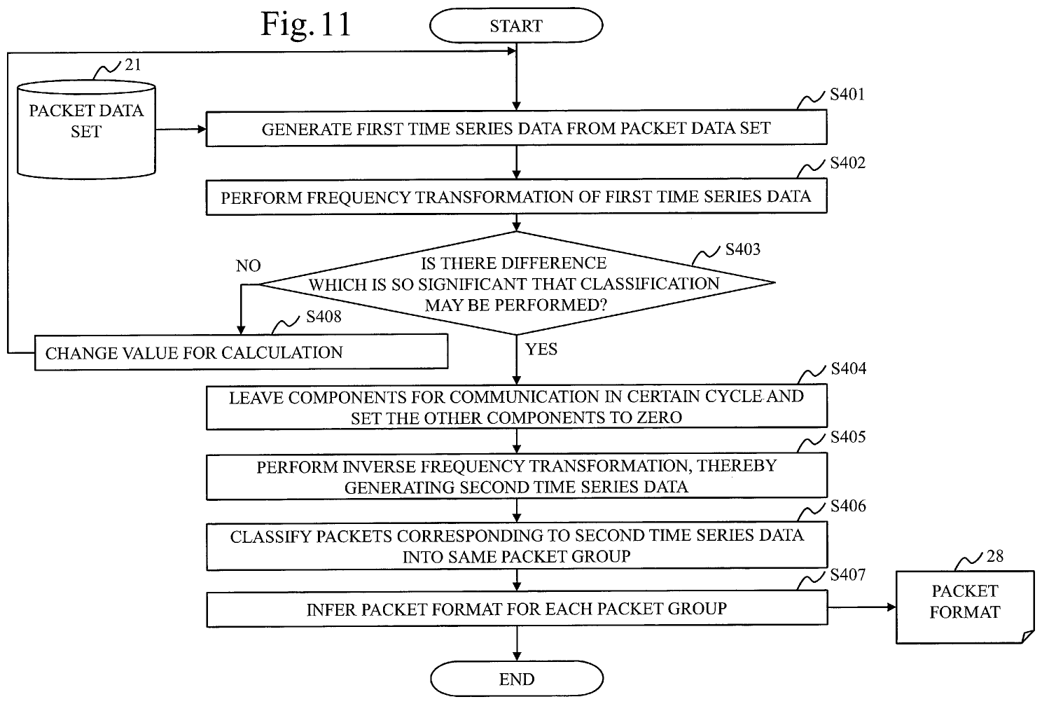

A difference of the fifth embodiment from the fourth embodiment will be mainly described, using FIG. 11.

### Description of Configuration

A configuration of a packet format inference apparatus 10 according to this embodiment is the same as that in the second embodiment illustrated in FIG. 7.

### Description of Operations

Operations of the packet format inference apparatus 10 according to this embodiment will be described with reference to FIG. 11. The operations of the packet format inference apparatus 10 correspond to a packet format inference method according to this embodiment.

In step S401 for a first time, a generation unit 22 selects one of a plurality of packets as a sample. In this embodiment, the one of the “plurality of packets” which are included in a packet data set 21 as packet data 41 and of which formats are unknown is randomly selected as the sample. The generation unit 22 calculates a value obtained by subtracting, from a common value Vc to each packet included in at least a portion of the packets among the “plurality of packets”, a hamming distance between the sample and each packet. In this embodiment, all the packets among the “plurality of packets” correspond to the “at least a portion of the packets”. An arbitrary fixed value can be used as the common value Vc. In this embodiment, however, a maximum value that can be possible in time series data is used. The generation unit 22 generates first time series data 29 indicating the value that has been calculated as an amplitude corresponding to the arrival time of each packet.

Processes in step S402 and step S403 are the same as those in step S302 and step S303. If there is a significant difference in step S403, processes after step S404 are performed. On the other hand, if there is not the significant difference, a process in step S408 is performed.

In step S408, a change unit 34 changes the value that is calculated by the generation unit 22 to the hamming distance between the sample and each packet included in the “at least a portion of the packets”. That is, the change unit 34 changes the time series data generation method. Then, the processes after step S401 are performed again.

In step S401 for a second time, the sample selection process is omitted. That is, the generation unit 22 calculates the hamming distance between each packet included in the “at least a portion of the packets” and the sample selected in step S401 for the first time. The generation unit 22 generates first time series data 29 indicating the hamming distance that has been calculated as an amplitude corresponding to the arrival time of each packet. Then, a process in the step S402 is performed.

In step S403 for the second time, the change unit 34 outputs an error indicating that no cycle can be extracted if there is not the significant difference. If the significant difference does not appear even when the time series data generation method is changed, the change unit 34 may change the sample that is selected by the generation unit 22, as in the third embodiment. After the sample has been changed, the processes after step S401 are performed again.

### Description of Effect of Embodiment

When one of the packets that have been transmitted in a cycle desired to be extracted is selected as the sample, the method of newly applying, as a binary value in the time series data, the value obtained by subtracting the hamming distance with the randomly sampled packet from the maximum value that can be possible in the time series data is effective. On the other hand, when the packet other than the packets that have been transmitted in the cycle desired to be extracted is selected as the sample, the method of newly applying, as a binary value in the time series data, the hamming distance itself with the randomly sampled packet is effective. In this embodiment, when the significant difference is not obtained even if one of the above-mentioned two methods is used as the time series data generation method, the other of the above-mentioned two method is used for the same sample, thereby facilitating the significant difference to be obtained.

### Alternative Configuration

It can be suitably changed which one of the above-mentioned two methods is to be used first.

### REFERENCE SIGNS LIST

10: packet format inference apparatus; 11: processor; 12: memory; 13: input interface; 14: auxiliary storage device; 15: display interface; 21: packet data set; 22: generation unit; 23: transformation unit; 24: extraction unit; 25: inverse transformation unit; 26: classification unit; 27: inference unit; 28: packet format; 29: first time series data; 30: first frequency spectrum; 31: second frequency spectrum; 32: second time series data; 33: packet group; 34: change unit; 41: packet data; 42: arrival time data

1. A packet format inference apparatus comprising:
processing circuitry
to classify, among a plurality of packets that have arrived, relevant packets transmitted in a fixed cycle, as a packet group having a same arrival cycle; and
to infer a packet format for each packet group having the same arrival cycle.

2. The packet format inference apparatus according to claim 1,
the processing circuitry
extracts, from a same location of each packet included in at least a portion of the packets among the plurality of packets, data having a same length and generates first time series data indicating a value of the data that has been extracted, as an amplitude corresponding to an arrival time of each packet;
performs frequency transformation of the first time series data generated and output a first frequency spectrum;
extracts, from the first frequency spectrum output, frequency component corresponding to the fixed cycle and output a second frequency spectrum; and
performs inverse frequency transformation of the second frequency spectrum output and output second time series data,
wherein the processing circuitry identifies the relevant packets by referring to the second time series data output.

3. The packet format inference apparatus according to claim 2,
the processing circuitry
changes the location of each packet included in the at least a portion of the packets, from which the data is extracted, when frequency component, corresponding to the fixed cycle, included in the first frequency spectrum output is smaller than a reference value.

4. The packet format inference apparatus according to claim 2,
wherein the processing circuitry selects one packet among the plurality of packets as a sample and uses, among the plurality of packets, each packet having a value within a set range from a value of the sample, as the at least a portion of the packets.

5. The packet format inference apparatus according to claim 2,
wherein the processing circuitry selects one packet among the plurality of packets as a sample, and uses, among the plurality of packets, each packet whose hamming distance with the sample is within a set range, as the at least a portion of the packets.

6. The packet format inference apparatus according to claim 1,
the processing circuitry
selects one packet among the plurality of packets as a sample, calculates a hamming distance between the sample and each packet included in at least a portion of the packets among the plurality of packets, and generates first time series data indicating the hamming distance that has been calculated, as an amplitude corresponding to an arrival time of each packet;
performs frequency transformation of the first time series data generated and output a first frequency spectrum;
extracts, from the first frequency spectrum output, frequency component corresponding to the fixed cycle and output a second frequency spectrum; and
performs inverse frequency transformation of the second frequency spectrum output and output second time series data,
wherein the processing circuitry identifies the relevant packets by referring to the second time series data output.

7. The packet format inference apparatus according to claim 6,
the processing circuitry
changes a value calculated to a value obtained by subtracting, from a common value to each packet, the hamming distance between the sample and each packet included in the at least a portion of the packets when each frequency component, corresponding to the fixed cycle, included in the first frequency spectrum output is smaller than a reference value.

8. The packet format inference apparatus according to claim
the processing circuitry
selects one packet among the plurality of packets as a sample, calculates a value obtained by subtracting, from a value common to each packet, a hamming distance between the sample and each packet included in at least a portion of the packets among the plurality of packets, and generates first time series data indicating the value that has been calculated, as an amplitude corresponding to an arrival time of each packet;
performs frequency transformation of the first time series data generated and output a first frequency spectrum;
extracts, from the first frequency spectrum output, frequency component corresponding to the fixed cycle and output a second frequency spectrum; and
performs inverse frequency transformation of the second frequency spectrum output and output second time series data,
wherein the processing circuitry identifies the relevant packets by referring to the second time series data output.

9. The packet format inference apparatus according to claim 8, further comprising:
changes a value calculated to the hamming distance between the sample and each packet included in the at least a portion of the packets when frequency component, corresponding to the fixed cycle, included in the first frequency spectrum output is smaller than a reference value.

10. A computer readable medium having a packet format inference program to cause a computer to execute:
a process of classifying, among a plurality of packets that have arrived, relevant packets transmitted in a fixed cycle, as a packet group having a same arrival cycle; and
a process of inferring a packet format for the packet group having the same arrival cycle.

11. The packet format inference apparatus according to claim 3,
wherein the processing circuitry selects one packet among the plurality of packets as a sample and uses, among the plurality of packets, each packet having a value within a set range from a value of the sample, as the at least a portion of the packets.

12. The packet format inference apparatus according to claim 3,
wherein the processing circuitry selects one packet among the plurality of packets as a sample, and uses, among the plurality of packets, each packet whose hamming distance with the sample is within a set range, as the at least a portion of the packets.
